(19) United States
(12) Patent Application Publication
(10) Pub. No.: US 2007/0075029 A1
(43) Pub. Date: Apr. 5, 2007

(54) Feeding bottle

(75) Inventor: Adam Yates, Hornbeam Park (GB)

Correspondence Address: MCKEE, VOORHEES & SEASE, P.L.C., 801 GRAND AVENUE, SUITE 3200, DES MOINES, IA, 50309-2721, US

(73) Assignee: LINDAM LIMITED, Hornbeam Park (GB)

(21) Appl. No.: 11/240,753

(22) Filed: Sep. 30, 2005

(51) Int. Cl. A61J 11/00; A61J 9/04; A61J 11/02

(52) U.S. Cl. 215/11.5; 215/11.1

(57) ABSTRACT

A feeding bottle is provided which includes a body portion for the containment of fluid therein. At least one opening is defined in the body portion for location of a feeding teat therewith. A venting aperture is provided for allowing venting of the body portion and the venting aperture is provided with closure means. The venting aperture is in communication with air inlet means, at least part of said air inlet means being substantially flexible. The closure means are movable relative to the air inlet means between an open position, wherein the air inlet means is open, and a closed position, wherein the at least flexible part of said air inlet means flexes to close the air inlet means.

### FEEDING BOTTLE

This invention relates to feeding bottles, and particularly but not necessarily exclusively to feeding bottles for use in feeding babies and infants.

Conventionally, feeding bottles include a body portion in which the feeding fluid is located and a teat located over an open end of said body portion to allow a child to suck the fluid from the body portion.

In order to reduce or remove the risk of colic in babies or infants using such bottles, it is known to provide a venting aperture in the body portion of the feeding bottle, typically adjacent the base of the body portion, to prevent the formation of a vacuum in the bottle. In order to prevent fluid leaking from said venting aperture, a number of closure mechanisms for use with said venting aperture have been proposed. An example of such a closure mechanism is disclosed in W099/11218, wherein a plurality of venting apertures arc defined in a perforated elastomeric diaphragm located over an open end of the base of a bottle, opposite to the teat covered open end. When the bottle is inverted the venting apertures in the diaphragm move to an open position and air can flow through the same and into the bottle. When the bottle is upright the venting apertures in the diaphragm move to a closed position and air is prevented from entering the bottle. A problem associated with this type of closure mechanism is that it is susceptible to leakage. In addition, a user feeding the baby has no control over the air being vented into the bottle.

In an attempt to overcome the abovementioned problems, it is known to provide a manually controlled closure mechanism. An example of a manually controlled closure mechanism for a venting aperture in a feeding bottle is disclosed in GB2370787. The closure mechanism includes a stopper assembly which is pivotally mounted on the bottle body for movement between a closed position, wherein the stopper of the assembly is located over the venting aperture to close the same, and an open position, wherein the stopper of the assembly is located a spaced distance apart from the venting aperture to allow air to enter the aperture. The stopper assembly is resiliently biased to the closed position during normal by biasing means in the form of a projecting tongue which engages with the side of the feeding bottle in use. If venting of the feeding bottle is required, a user pivots a handle portion of the stopper assembly to move the stopper of the assembly away from the venting aperture to the open position.

The applicant's co-pending patent application provides an improved closure mechanism for a feeding bottle

It is an object of the present invention to provide an alternative closure mechanism for a feeding bottle.

According to a first aspect of the present invention there is provided a feeding bottle, said feeding bottle including a body portion for the containment of fluid therein, at least one opening defined in said body portion for location of feeding means therewith in use and at least one venting aperture for allowing venting of said body portion, said at least one venting aperture provided with closure means, and wherein the at least one venting aperture is in communication with air inlet means, at least part of said air inlet means being substantially flexible, and said closure means movable relative to said air inlet means between an open position, wherein the air inlet means is open, and a closed position, wherein the at least flexible part of said air inlet means flexes to close said air inlet means.

The closure means engages one or more surfaces of the air inlet means to allow flexing of the same the close the air inlet means. The closure means can, for example, engage opposite surfaces of the air inlet means to provide a pinching type of effect to closure the air inlet means. Alternatively, the closure means can, for example, engage a surface of the air inlet means and push the air inlet means against a further surface to cause the same to flex to a closed position.

With the air inlet means in a closed position, the venting aperture is also in a closed position (i.e. air is prevented from entering the same and/or fluid is prevented from exiting the body portion via the venting aperture).

The feeding means can include a feeding teat and/or the like.

Preferably the air inlet means includes at least one channel portion and at least one seat portion. The at least one seat portion has an aperture defined therein which communicates with the channel of said channel portion.

Preferably the at least one seat portion engages with part of the body portion surrounding the at least one venting aperture, such that the aperture in said seat portion is substantially aligned with the venting aperture. The seat portion is typically in sealing engagement with the body portion.

The at least one channel portion typically protrudes outwardly from the body portion when the seating portion is located with the body portion. At least a part or whole of said channel portion is formed from substantially flexible material and said closure means typically moves relative to or with said channel portion.

Preferably the closure means includes at least one actuation member for allowing manual user actuation of said closure means between said open and closed positions.

In a preferred embodiment two actuation members are provided. These actuation members can be provided on opposite sides of the bottle, thereby allowing a user to actuate the same irrespective of whether they are left handed, tight handed and/or the position of their hand with respect to the bottle.

Preferably the closure means are located in or form part of a housing. The housing can be attached via attachment means or integrally formed with the body portion.

The housing can be detachably attached to the body portion at any suitable location.

In a preferred embodiment the housing is attached to the base of the body portion. Thus, in one example, the housing forms a base of the feeding bottle.

The attachment means can include any or any combination of adhesive, bayonet fitting, complementary groove/protrusion engagement, inter-engaging members, friction fit, one or more ties, clips, screws and/or the like.

Preferably the at least one user actuation member is slidably mounted on said housing.

In one embodiment the closure means further includes at least one closure member which engages with said flexible part of said air inlet means, at least in said closed position.

In one embodiment the closure member is attached to said actuation member so that movement of said actuation member results in movement of said closure member between said open and closed positions.

Preferably the closure member and/or said user actuation member are resiliently biased to said closed position.

Preferably the biasing means includes a substantially annular member which is located around said closure means and said housing and/or located between two closure means.

Preferably locking means are provided on or associated with said closure means for preventing movement of the same between said open and closed positions.

In one embodiment said locking means includes at least one tab member which is movably located in the path of at least a part of said closure means to prevent movement of the same in a locked position. Preferably the tab is slidably movable with respect to said closure means.

In one embodiment the locking means include a rotatably mounted member. The rotatably mounted member can be rotated between a first locked position, wherein movement of the user actuation members towards each other is prevented, a second unlocked position, wherein movement of at least one of the user actuation members towards the other member is enabled.

Preferably one or more recess portions arc provided on the rotatable member and, when said one or more recess portions are substantially in alignment with said closure means and/or said user actuation members, the locking means are in an unlocked position.

The rotatably mounted member is typically a substantially disc shaped member, although the member could be any suitable shape.

Preferably one or more arm portions are provided on the closure means and said arm portions are arranged such that movement of a user actuation member inwardly of the housing moves said closure member away from said channel portion, thereby allowing air to enter the channel portion and through the venting aperture into the body portion of the bottle.

According to a second aspect of the present invention there is provided a venting mechanism for use with a feeding bottle.

According to a further aspect of the present invention there is provided a feeding bottle having closure means, charactcrised in that at least one venting aperture is provided on said feeding bottle and said closure means is in the form of a valve assembly which is movable between an open position, wherein air can enter the venting aperture, and a closed position, wherein air is prevented from entering the venting aperture.

According to a yet further aspect of the present invention there is provided a feeding bottle having a first surface which is substantially concave in shape and an opposite surface which is substantially convex in shape.

The present invention has the advantage that the bottle can be taken apart and assembled and the components of the same can be easily sterilised, cleaned, replaced and/or repaired. In addition, the invention provides an effective alternative closing mechanism which reduces the likelihood of leakage and provides a good seal between the closure means and the venting aperture with the closure means in a closed position.

Embodiments of the present invention will now be described with reference to the accompanying figures, wherein:

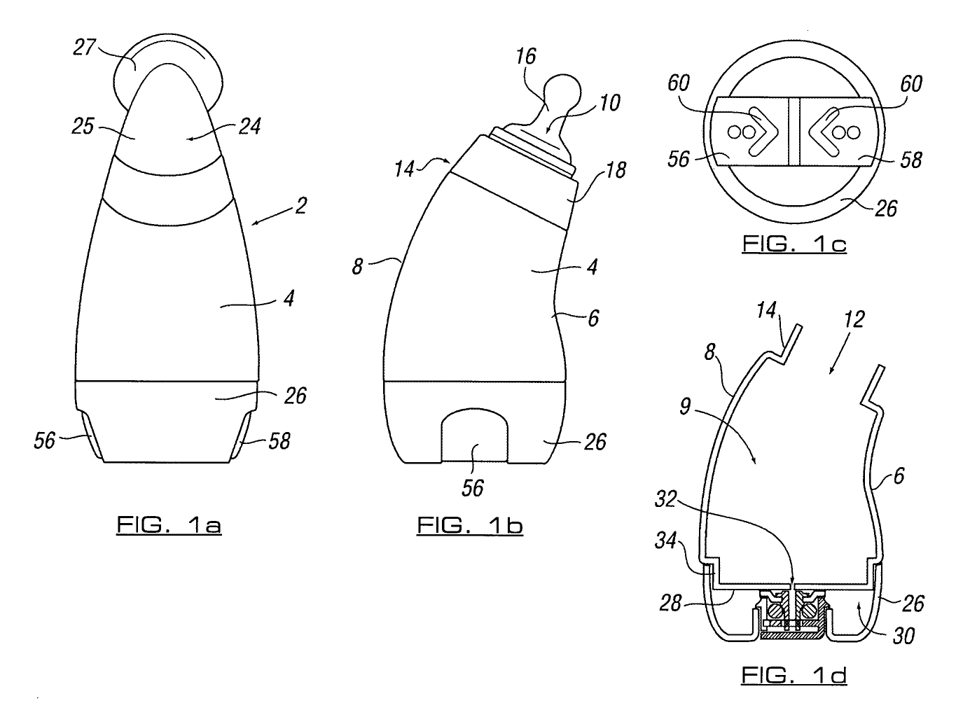

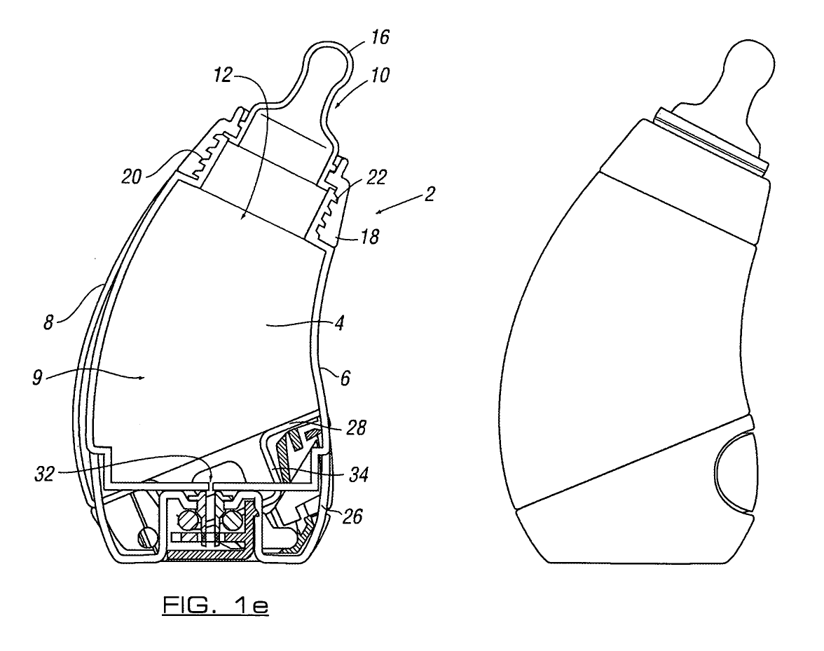

FIG. 1a is a front view of a feeding bottle according to the present invention;

FIG. 1b is a side view of the feeding bottle in FIG. 1a without the closure cap thereon;

FIG. 1c is a view of the feeding bottle in FIG. 1a from the base;

FIG. 1d is a simplified line drawing of a side view of the feeding bottle without the teat assembly attached thereto;

FIG. 1e is a cross sectional view taken through the feeding bottle in figure 1b;

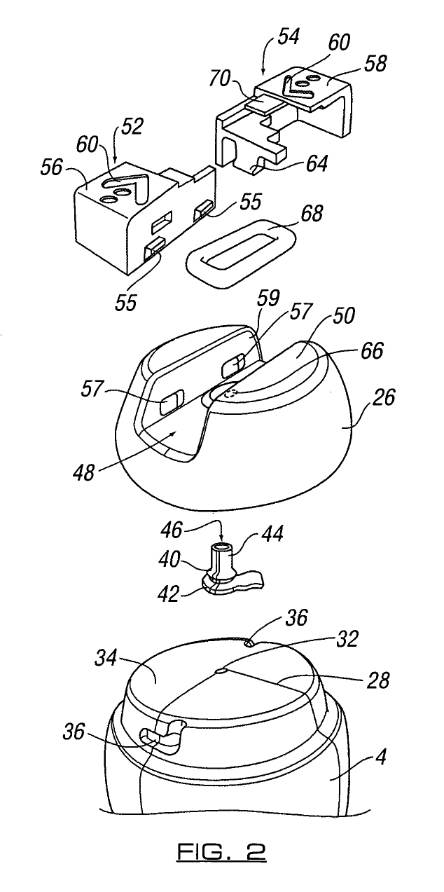

FIG. 2 is an exploded view of the closure means of the feeding bottle in one embodiment;

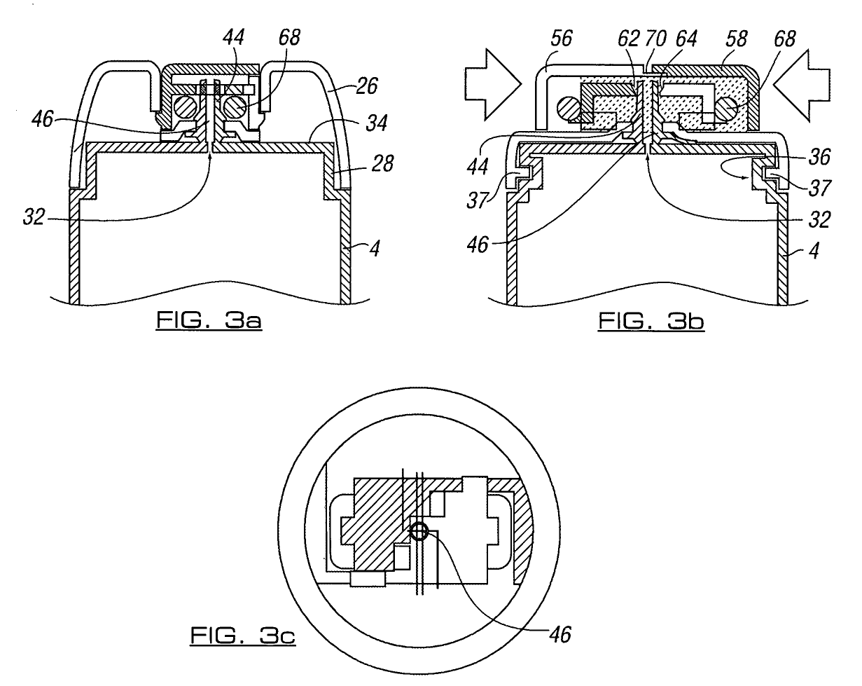

FIGS. 3a-3c show side, front and plan view of the base of the feeding bottle with the closure means in an open position;

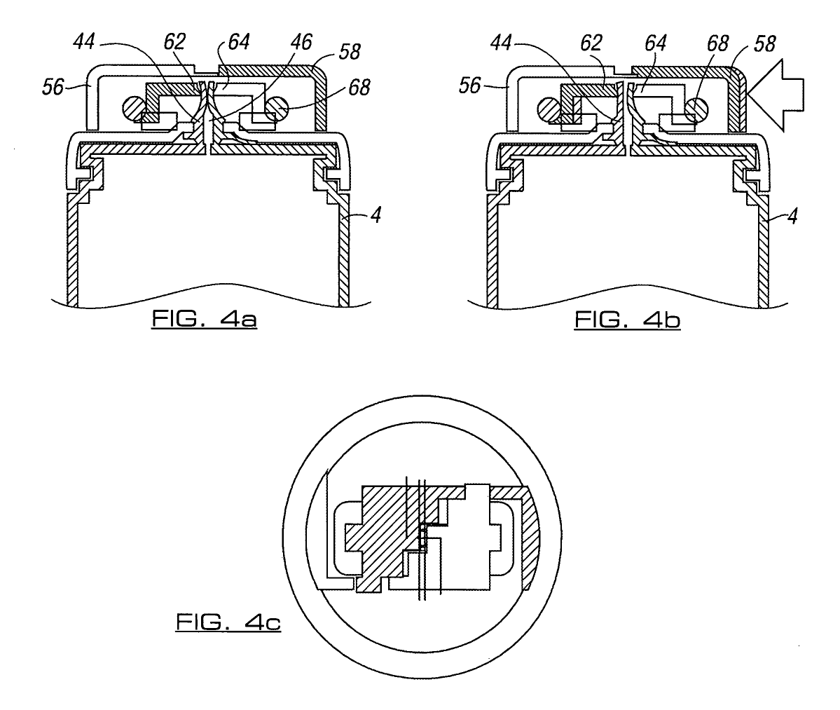

FIGS. 4a-4c show the closure means in a closed position, a partially closed position and a plan view of the base in a partially closed position respectively;

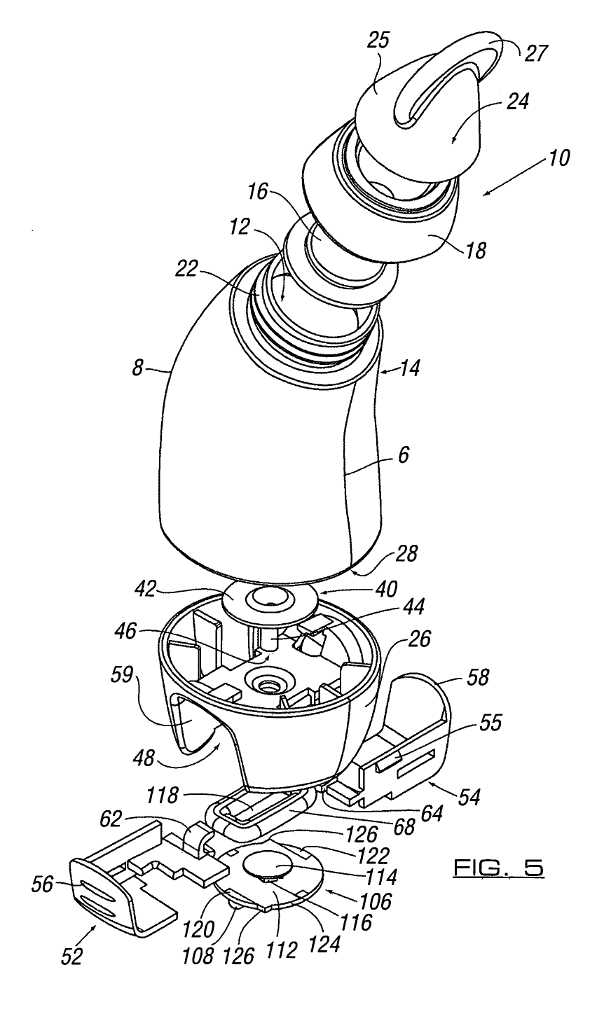

FIG. 5 is an exploded view of the feeding bottle with locking means according to a second embodiment;

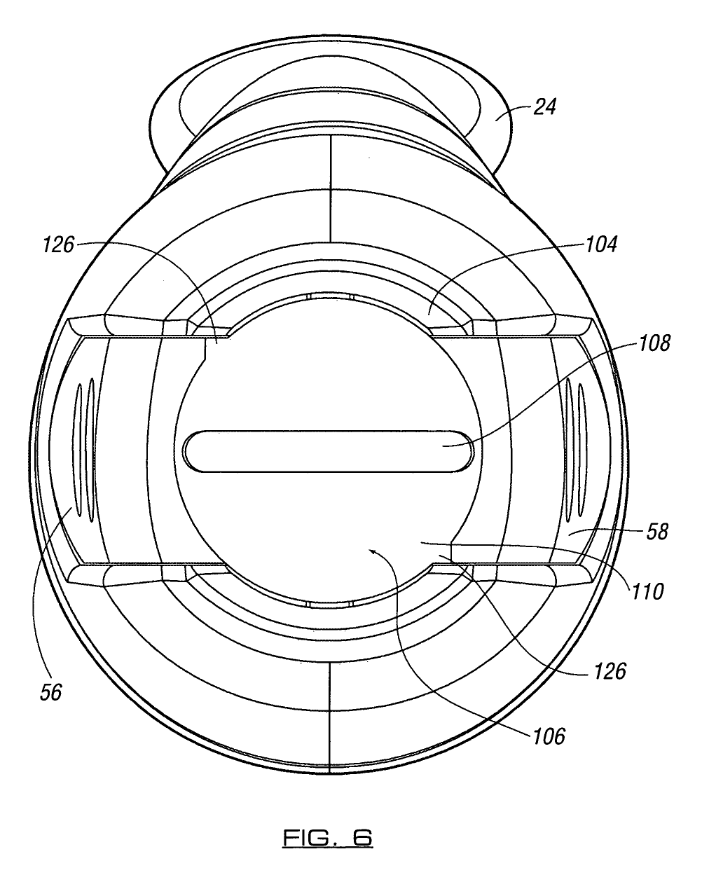

FIG. 6 is a view from the base of the bottle in FIG. 5; and

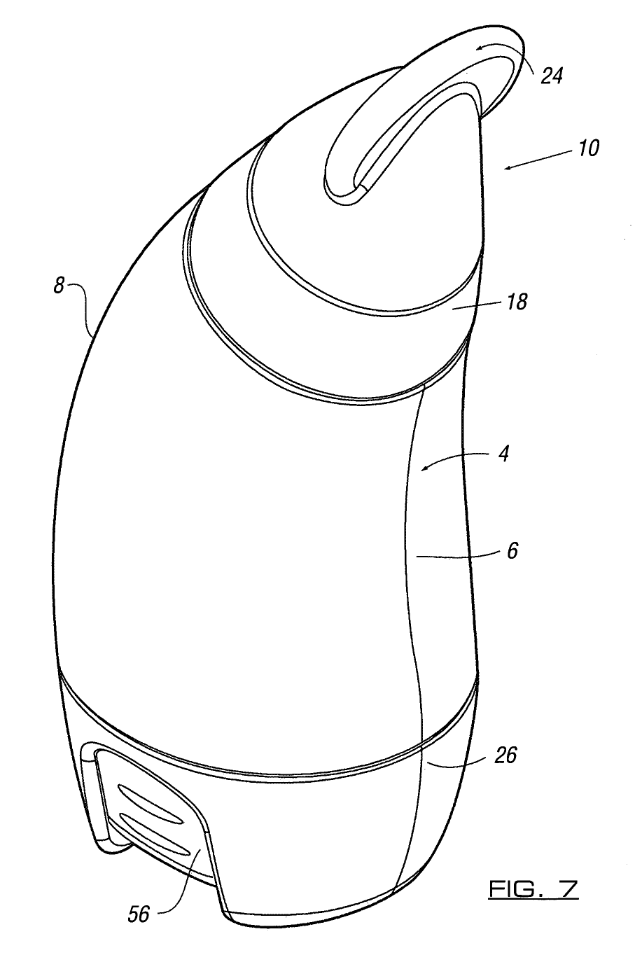

FIG. 7 is a perspective view of the bottle in FIG. 5.

Referring to FIGS. 1-4c, there is illustrated a feeding bottle 2 for use in feeding babies and infants milk or some other suitable fluid formulae.

The feeding bottle 2 includes a body portion 4 which is curved in shape, with a front surface 6 being substantially concave in shape when viewed from the side and the rear surface 8 being substantially convex in shaped when viewed from the side. A cavity 9 is defined in the body portion for the containment of fluid therein.

A teat assembly 10 is provided over an open end 12 adjacent a top 14 of body portion 4. The teat assembly 10 includes a teat 16 which has a slit therein to allow a baby or infant to suck fluid therefrom when the bottle is inverted. The teat 16 is fitted to skirt member 18 which has a screw threaded portion 20 on an interior surface thereof. The screw threaded portion 20 is complementary to a screw threaded portion 22 provided on the exterior surface of body portion 4 adjacent top 14, thereby allowing releasable engagement of the skirt member with the body portion.

A closure cap 24 can be inserted over teat 16 for engagement with skirt member 18 to prevent the teat from becoming damaged or dirty when not in use. The cap 24 can engage with or over the skirt member 18 via a friction fit or via any other suitable engagement means.

The closure cap 24 in this example has a dome shaped or cone shaped lid portion 25 with an upstanding gripping portion 27 protruding from an upper part thereof to allow a user to easily grip and remove the closure cap from the bottle.

A housing 26 is detachably attached to the base 28 of body portion 4 and, when fitted, defines a cavity 30 between the base and housing for the location of closure means therebetween.

A venting aperture 32 is defined in protrusion 34 of base 28 and the closure means can be moved between open and closed positions to open and close the venting aperture as required. It will be appreciated that the venting aperture can be positioned at any suitable location on the body portion of the bottle and is not simply confined to the protrusion of the base. With the venting aperture open, air can enter the feeding bottle and prevent vacuum formation in the bottle when the baby is feeding and the bottle is inverted. With the venting aperture closed and the bottle in an upright position, fluid in the feeding bottle is prevented from escaping through the venting aperture.

Housing 26 is attached to base 28 via a bayonet fitting, More specifically, L-shaped grooves 36 are provided on either side of protrusion 34 and peg members 37 provided on opposite interior side walls of housing 26 locate in the L-shaped grooves and are locked in place by twisting housing 26 with respect to base 28.

Air inlet means in the form of a substantially flexible member 40 is provided in communication with venting aperture 32. More specifically, member 40 includes a seating portion 42 and a channel portion 44 protruding from said seating portion. An aperture (not shown) is provided at one end of the seating portion 42 and this aperture communicates with a channel 46 defined through channel portion 44. The seating portion is brought into sealing engagement with the surface of protrusion portion 34 surrounding aperture 32, such that the aperture in the seating portion is aligned with the venting aperture 32.

Housing 26 has a channel 48 defined in a base 50 thereof. Closure means 52, 54 are slidably mounted in said channel 48 when assembled. Engagement means in the form of protrusion portions 55 ate provided on one or more sides of the closure means for engagement in recesses 57 defined in side walls 59 of channel 48 to prevent the closure means 52, 54 from becoming detached from base 50. Recesses 57 have a greater length than the length of portions 55, thereby allowing portions 55 to 'slide therein in a direction longitudinally of base 50 and channel 48 between open and closed positions.

Closure means 52, 54 include user actuation portions 56, 58 respectively which can have instructions, symbols or arrows 60 provided thereon to indicate to a user the direction they must move the actuation portions in order to vent the feeding bottle.

Closure means 52, 54 further include closure members 62, 64 thereon respectively. When the bottle is assembled, channel portion 44 of the air inlet means 40 protrudes through an aperture 66 (shown by dotted lines) defined in the base of channel 48 and between said closure members 62, 64.

With the closure means in a closed position, closure members 62, 64 pinch into opposite side walls of channel portion 44, as shown in FIG. 4a. Resilient biasing means in the form of an annular elastomeric member 68 is located between the closure members 62, 64 and engages around the back of each closure member forcing the members together. Since closure members 62, 64 are substantially in alignment, this biased engagement against the side walls of channel portion 44 causes the side walls to flex inwardly to close channel 46 defined in said channel portion 46. This prevents air from entering venting aperture 32 in body portion 4 of the feeding bottle.

Movement actuation means are also provided on closure means 52, 54 in the form of arm portions 70. On movement of one of the closure means 52, 54 relative to the other, or on movement of the closure means towards each other with such a force so as to overcome the biasing force of member 68, closure members 62 and/or 64 are moved away from each other, thereby removing the pinching force on channel portion 44 and allowing air to eater channel 46 to vent aperture 32.

Locking means in the form of a slidable tab can be provided on housing 26 for slidable movement in a direction substantially perpendicular to the sliding action of the closure means between a locked position, wherein the tab is located between opposite surfaces of the user actuation portions to prevent movement of the user action portions towards each other, and an unlocked position, wherein the tab is removed from the space between opposite surfaces of the user actuation portions, thereby allowing movement of the user action portions towards each other.

Referring to FIGS. 5-7, an example of a bottle 102 incorporating locking means according to a further embodiment of the present invention is illustrated. The same reference numerals are used to designate the same features as in FIGS. 1-4c. In this example, the user actuation portions 56, 58 are provided more on the side of the bottle than in FIGS. 1-4c and the base 104 of housing 26 is shaped so as to receive a locking member 106 which is disc shaped.

Locking member 106 has a tab 108 on an outer surface 110 thereof to act as a handle to allow a user to rotate the same between locked and unlocked positions. Inner surface 112 of member 106 has securing means in the form of a head portion 114 on an arm portion 116. This head portion is located through aperture 118 in annular member 68 and the size of the head portion is larger than aperture 118, such that the member 68 remains secured to locking member 106.

Recess portions 120, 122 are provided on opposite sides of inner surface 112 and when these recess portions are aligned with closure means 52, 54, the closure means are movable towards each other as previously described and said locking member is in an unlocked position. If a user rotates locking member 106 between 0-180 degrees, the recess portions 120, 122 are moved out of alignment with closure means 52, 54 and the outer edge 124 of locking member 106 prevents movement of the closure means towards each other.

Notches 126 can be provided on the outer edge of locking member 106 to limit movement of the locking member due to notches 126 engaging with either side walls 59 of channel 48 at the maximum limits of movement of the locking member.

Thus, it can be seen that the closure means of the present invention is in the form of a valve type assembly, wherein rather than plugging an aperture with a stopper, a pinch valve is provided.

The components of the feeding bottle can be formed in any size, shape and/or design and can be made from any or any combination of suitable material, such as metal, plastic, glass, wood, rubber and/or the like.

1. A feeding bottle, said feeding bottle including a body portion for the containment of fluid therein, at least one opening defined in said body portion for location of feeding means therewith in use and at least one venting aperture for allowing venting of said body portion, said at least one venting aperture provided with closure means, and wherein the at least one venting aperture is in communication with air inlet means, at least part of said air inlet means being substantially flexible, and said closure means movable relative to said air inlet means between an open position, wherein the air inlet means is open, and a closed position, wherein the at least flexible part of said air inlet means flexes to close said air inlet means.

2. A feeding bottle according to claim 1 wherein the air inlet means includes a channel portion and at least one seat portion, the at least one seat portion having an aperture defined therein which is in communication with said channel portion.

3. A feeding bottle according to claim 2 wherein the at least one seat portion engages with a part of the body portion surrounding the venting aperture, the aperture of the at least one scat portion communicating with the at least one venting aperture.

4. A feeding bottle according to claim 3 wherein the at least one seat portion is in scaling engagement with the body portion.

5. A feeding bottle according to claim 2 wherein at least a whole or part of the channel portion is substantially flexible and said closure means moves relative to said channel portion.

6. A feeding bottle according to claim 2 wherein the channel portion protrudes outwardly from the body portion when the air inlet means are engaged to said body portion.

7. A feeding bottle according to claim 1 wherein the closure means engages against one or more surfaces of said air inlet means to cause flexing of the same in said closed position.

8. A feeding bottle according to claim 1 wherein the closure means includes at least one actuation member for allowing manual user actuation of said closure means between said open and closed positions.

9. A feeding bottle according to claim 8 wherein two actuation means ate provided; one actuation means on each side of the bottle.

10. A feeding bottle according to claim 1 wherein the closure means are located in or form part of a housing, the housing being integrally formed with or attached via attachment means to the body portion.

11. A feeding bottle according to claim 10 wherein the housing forms a base of the feeding bottle.

12. A feeding bottle according to claim 10 wherein the housing is detachably attached to the body portion.

13. A feeding bottle according to claim 10 wherein the attachment means includes any or any combination of adhesive, bayonet fitting, complementary groove/protrusion engagement, one or more inter-engaging members, friction fit, one or more screws, ties or clips.

14. A feeding bottle according to claim 10 wherein the closure means are slidably mounted in the housing.

15. A feeding bottle according to claim 1 wherein the closure means are resiliently biased to said closed position via resilient biasing means.

16. A feeding bottle according to claim 15 wherein the resilient biasing means includes a substantially annular member located around the closure means and the housing and/or located between two closure members.

17. A feeding bottle according to claim 1 wherein locking means are provided on or associated with said closure means to lock the same in said open or closed positions.

18. A feeding bottle according to claim 17 wherein the locking means includes at least one tab member which is movably located in the path of at least a part of said closure means when in the locked position.

19. A feeding bottle according to claim 17 wherein the locking means includes a rotatably mounted member.

20. A feeding bottle according to claim 19 wherein one or more recesses are provided on said rotatable member and, when said one or more recesses are substantially in alignment with said closure means, the rotatable member is in an unlocked position and the closure means can be moved.

21. A feeding bottle according to claim 19 wherein the rotatably mounted member is in the form of a disc.

22. A feeding bottle according to claim 1 wherein the closure means includes one or more arm portions and the arm portions engage one or more surfaces of said air inlet means to close the same.

23. A venting mechanism for a feeding bottle according to claim 1.
